(19) United States
(12) Patent Application Publication
(10) Pub. No.: US 2015/0063812 A1
(43) Pub. Date: Mar. 5, 2015

(54) COMPENSATOR FOR WAVELENGTH DRIFT DUE TO VARIABLE LASER INJECTION CURRENT AND TEMPERATURE IN A DIRECTLY MODULATED BURST MODE LASER

(71) Applicant: Calix, Inc., Petaluma, CA (US)

(72) Inventors: Jason Dove, Novato, CA (US); Harold A. Roberts, Excelsior, MN (US)

(21) Appl. No.: 14/465,621

(22) Filed: Aug. 21, 2014

Related U.S. Application Data
(60) Provisional application No. 61/870,637, filed on Aug. 27, 2013.

(51) Int. Cl. H04Q 11/00; H04J 14/02; H04B 10/40

(52) U.S. Cl. CPC H04Q 11/0067; H04B 10/40; H04J 14/0221; H04Q 2011/0086
USPC 398/67; 398/136

(57) ABSTRACT

An optical node comprises a tunable optical transceiver having a laser and a temperature element. The optical node also comprises a wavelength shift stabilization circuit configured to adjust current provided to the temperature element such that wavelength shifts, due to changes in a drive current applied to the tunable optical transceiver, are reduced.

### CROSS-REFERENCE TO RELATED APPLICATIONS

This application claims priority to U.S. Provisional Patent Application No. 61/870,637, filed on Aug. 27, 2013 and entitled “COMPENSATOR FOR WAVELENGTH DRIFT DUE TO VARIABLE LASER INJECTION CURRENT AND TEMPERATURE IN A DIRECTLY MODULATED BURST MODE LASER”, which is referred to herein as the '637 application and incorporated herein by reference.

### BACKGROUND

For Wavelength-Division Multiplexed (WDM) Passive Optical Network (PON) implementations, such as gigabit passive optical network (GPON), it is generally accepted that it is desirable for the Optical Network Units (ONUs) to have tunable downstream receivers and tunable upstream lasers so that so-called ‘colorless’ ONUs can be deployed and the inventory complexity implied by colored ONUs can be avoided. As understood by one of skill in the art, colorless ONUs refer to ONUs that are not tuned to a specific wavelength, whereas colored ONUs are tuned for a specific wavelength.

While costs have dropped for both tunable receivers and lasers, they still remain significantly more expensive than fixed optical components. In addition, tunable receivers and lasers also suffer from temperature effects which may make it difficult to maintain precise wavelength tuning. Furthermore, lasers used in burst mode suffer from short term wavelength changes from the beginning of the burst until the wavelength stabilizes due to the abrupt injection of current from an off-burst to an on-burst state. Thus, precise tunable optical components are expensive and, if they need to operate in an environment with a wide temperature range, may not even be feasible. However, in order to implement some systems, such as Next Generation (NG)-PON2, low cost precision, tunable ONU optics are desired. NG-PON2 uses a combination of Time Division Multiple Access (TDMA) and WDM which has also been referred to as TWDM-PON. There is currently no market solution to this problem and it is currently an impediment to implementing NG-PON2. In other words, there is no economically feasible solution currently available to provide low cost precision, tunable ONU optics.

### SUMMARY

In one embodiment, an optical node is provided. The optical node comprises a tunable optical transceiver having a laser and a temperature element. The optical node also comprises a wavelength shift stabilization circuit configured to adjust current provided to the temperature element such that wavelength shifts, due to changes in a drive current applied to the tunable optical transceiver, are reduced.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of one embodiment of an exemplary optical system.

FIG. 2 depicts exemplary responses of lasers at different wavelengths to a slow change in temperature as the lasers transmit.

FIG. 3 depicts an exemplary response of an optical network unit laser to sudden temperature change.

FIG. 4 is a high level block diagram of one embodiment of an exemplary stabilized tunable optical network unit.

FIG. 5 is a high level block diagram of another embodiment of an exemplary stabilized tunable optical network unit.

FIG. 6 is a flow chart depicting one embodiment of an exemplary method of stabilizing the variation in laser wavelength.

FIG. 7 is a circuit diagram of one embodiment of an exemplary dual diode mechanism.

In accordance with common practice, the various described features are not drawn to scale but are drawn to emphasize specific features relevant to the exemplary embodiments

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

The embodiments described herein provide a distributed feedback tuning mechanism to improve the performance of a tunable laser that is operating within a WDM PON while at the same time increasing the allowable wavelength tolerances in manufacturing which lowers the laser manufacturing costs as well as mitigates problems associated with wavelength drift over temperature. In addition, tunable receivers can benefit by application of the embodiments described herein.

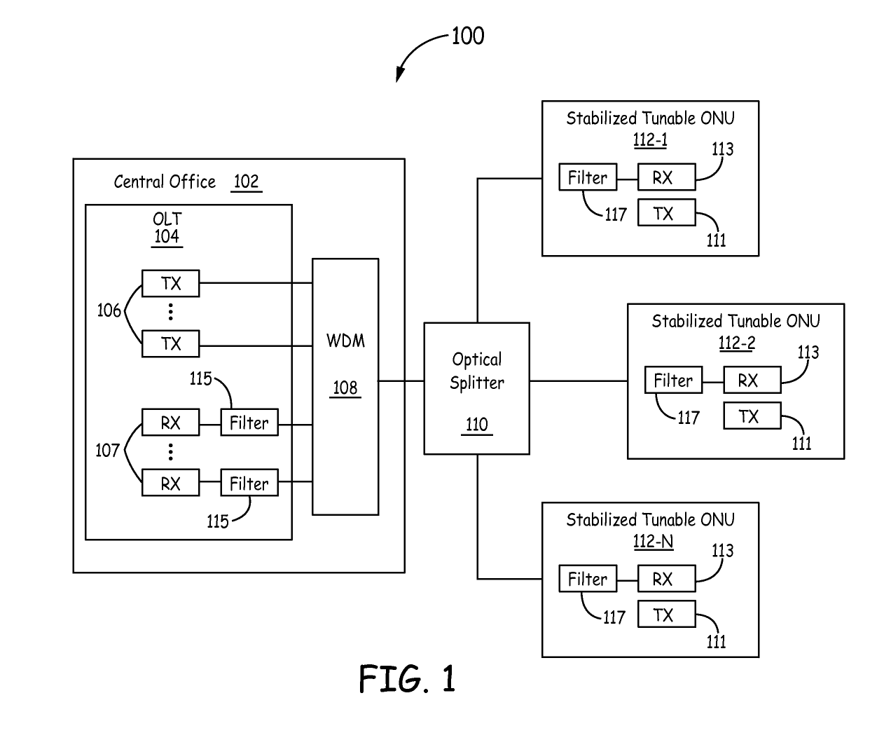

FIG. 1 is a high level block diagram of one embodiment of an exemplary optical network 100. Optical network 100 includes a central office 102 having one or more Optical Line Terminals (OLT) 104. The OLT 104 includes a plurality of optical transmitters 106 and a plurality of optical receivers 107. Each transmitter 106 and each receiver 107 is operable over a respective wavelength. The OLT 104 also includes a wavelength division multiplexer (WDM) 108 configured to multiplex the signals from the plurality of transmitters 106 and to separate signals directed to each of the plurality of receivers 107. The WDM 108 outputs the optical signal containing the multiplexed wavelengths from the enhanced OLT 104 to the optical distribution network.

The system 100 also includes a splitter 110 located in the optical distribution network. The splitter 110 is configured to provide signals to each of a plurality of stabilized tunable optical network units (ONU) 112. Each of the ONUs 112 is tunable to operate over a respective wavelength. In addition, each of ONUs 112 is configured to stabilize the short term wavelength drift as described below. Each of the ONUs 112 includes a transmitter 111 and a receiver 113.

As used herein, a tunable receiver is a receiver which has a broadband wavelength response from its photodetector and that has a narrowband tunable filter in front of the broadband photodetector. In this way the receiver can block out the undesired wavelengths while admitting the desired wavelength. In some embodiments, a tunable filter is continuously tunable, meaning that the filter does not have discrete quantized wavelengths but rather can make arbitrarily small wavelength adjustments via some voltage, temperature or other controlling mechanism. The receiver has access to the received signal strength level indicator (RSSI) and therefore can adjust the center wavelength of the tunable filter to maximize the received signal strength (RSS) using well-known algorithms for finding the maximum peak of a function. Note that for NG-PON2 (also referred to as time and wavelength division multiplexed PON (TWDM-PON)) the allowable spectrum that is tuned across is small (e.g. on the order of nanometers). In some embodiments, the spectrum is as small as 3 nanometers.

It is typically simpler and cheaper to tune across small wavelength regions, especially if the tunable filter does not need to be calibrated or precisely ‘know’ the wavelength it is tuned to. Instead, the burden is placed upon software to a) Maximize the RSS of a received wavelength by centering the filter around the specific wavelength using an adaptive algorithm designed to maximize signal strength; b) Determine, via management messages from the Optical Line Terminal (OLT) 104, what channel it has tuned to and whether it is the ‘correct’ channel for that ONU 112; and c) use the information from a & b to make a best guess about the proper tuning parameters for the channel the respective ONU 112 should tune to (assuming the initial channel is not correct).

Once each respective ONU 112 has downstream communication from the OLT 104, then it can be told what the appropriate upstream wavelength is by periodic management messages broadcast by the OLT 104. This information is used in the upstream wavelength tuning process described below.

Applying a feedback tuning method, such as described above, is not as simple with the ONU transmitter 111 as with the ONU receiver 113. With respect to the ONU transmitter 111, each respective multi-wavelength OLT receiver 107 cooperates in the distributed tuning process to enable each ONU 112 to properly tune its upstream laser transmission wavelength. Again, as with the receiver, the tunable laser can be made less expensively and potentially operate over a wider temperature range if precise knowledge of the laser wavelength by the ONU 112 is not necessary and if the tuning range is narrow. However, the implication of an imprecise ONU laser is that ranging includes a wavelength tuning process whereas with current fixed wavelength PONs the only processes necessary for adjustment are the adjustment of timing (Round Trip Delay) and possibly the transmit power level.

In the embodiments described herein, each ONU 112 attempts to range on a wavelength as close as possible to what the desired or default wavelength is. If no response from the OLT 104 is received, then the laser incrementally adjusts the transmit wavelength in a specific direction and tries to range again. Once the laser is transmitting within the receive wavelength window of one of the OLT upstream receivers 107, then the OLT 104 will communicate with the respective ONU 112 on all of the valid downstream wavelengths what the actual upstream wavelength the ONU is transmitting on. Since the respective ONU 112 already knows what its ‘correct’ wavelength should be, it will know if it is on the correct wavelength. If it is, the ranging process will include additional ‘fine-tune’ wavelength adjustments to center the ONU laser wavelength to the center of the OLT receiver filter for minimum loss and maximum received signal at the OLT 104.

If the respective ONU 112 is transmitting at the wrong wavelength window, then the ONU 112 will adjust the transmit wavelength to attempt to transmit at the correct wavelength. Since the ONU 112 will have been ‘calibrated’ to the alternate wavelength it will more likely tune close to the center of the correct OLT receive filter as the ONU will be ‘partially calibrated’ in the field. Then, the feedback process between the OLT 104 and the respective ONU 112 will continue until the ONU 112 is fine-tuned to the center of the correct OLT receiver window. To avoid interference on other wavelength PONs, the ranging windows of all of the PONs can be aligned so that the transmissions of a laser tuned to the wrong upstream wavelength will fall harmlessly in the other channel's quiet (or ranging) windows.

With a fixed WDM scheme, a fraction of a decibel of loss can occur when the ONU laser transmitter 111 is not precisely centered at the minimum loss point of the OLT receiver bandpass filter 115. The bandpass filter 115 does not have a flat passband and therefore being in the passband does not guarantee being at the lowest loss point. The embodiments described herein help ensure that the ONU is precisely centered in the lowest loss point of the OLT receiver filter. In addition, even the OLT receiver filter 115 may be reduced in cost as the minimum loss wavelength does not need to be absolute, but can exist within a wavelength window of tolerance, whereby the ONU will ‘lock’ to the center of the receiver filter 115. The same cost reduction can be done in the OLT laser as the ONU will ‘find’ the optimal center for the tunable ONU receiver filter 117. Additionally, the wavelength tuning processes can be on-going at both the ONU transmitter and receiver to maintain wavelength lock over temperature and other environmental considerations. Thus, the embodiments described herein provide a low cost tunable laser for each ONU 112, whereby the ONU laser transmitter 111 has relaxed tolerances and relies on feedback from the OLT 104 to adjust wavelength.

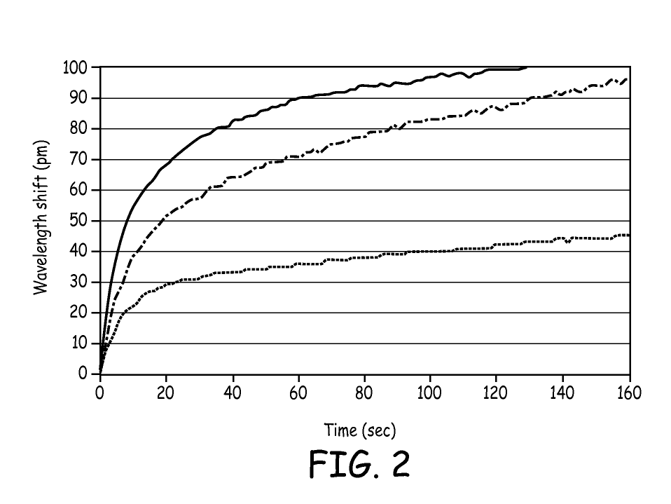

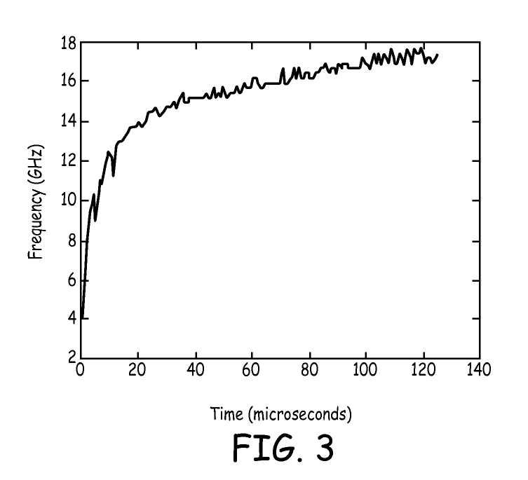

The wavelength control of a burst mode laser is complicated by the thermal impact of varying the average current (and hence heat and temperature) due to the varying duty cycle under which a burst mode laser operates. The varying average current in turn changes the laser die temperature which changes the wavelength at the well-known rate of 0.09 nm per degree Celsius. The effects of this relatively slow change in temperature during a burst transmission on different wavelengths is shown in FIG. 2. In FIG. 2, the variation in wavelength is shown on a scale of seconds. This referred to herein as long term wavelength drift. However, much faster wavelength changes can also occur due to the sudden temperature change when beginning to transmit after having been in the off state as shown in the exemplary FIG. 3. As shown in FIG. 3, the frequency in gigahertz changes sharply in the first few microseconds after turning on the laser due to the sudden change in temperature associated with turning on the laser. As known to one of skill in the art, the wavelength is associated with the frequency by the known function, ƒλ=c (frequency times wavelength equals the speed of light). Thus, the wavelength changes sharply in the few first microseconds as well. This drift is referred to herein as short term wavelength drift.

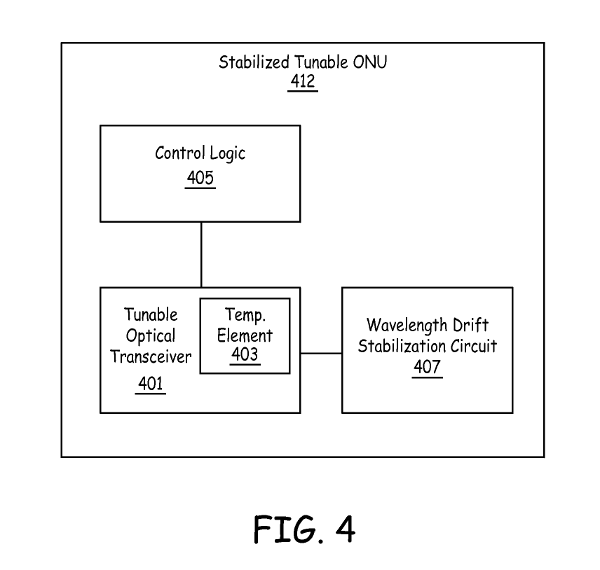

FIG. 4 is a high level block diagram of one embodiment of an exemplary stabilized tunable ONU 412. The ONU 412 can be used to implement the stabilized tunable ONUs 112 in system 100. ONU 412 includes a tunable optical transceiver 401. As understood by one of skill in the art, a transceiver includes a transmitter and a receiver. The optical transceiver 401 is configured to tune its upstream laser transmission wavelength and to block out the undesired wavelengths of received signals while admitting the desired wavelength. The tunable optical transceiver 401 includes a temperature element 403, such as a heater or TEC, to tune the upstream and downstream wavelength, as discussed below. The ONU 412 also includes control logic 405 configured to control the tunable optical transceiver 401 to adjust the upstream and downstream wavelength. In addition, the ONU 412 includes a wavelength drift stabilization circuit 407. The stabilization circuit 407 is configured to adjust current to the temperature element 403 in order to counteract temperature changes due to changes in the drive current, as discussed below.

The techniques described herein enable stabilizing the short term wavelength drift of low cost tunable burst mode lasers such as the laser transceiver 401 in the stabilized ONU 412. In particular, a simple, low cost method of stabilizing the variation in laser wavelength due to the temperature induced wavelength shift from variable average drive current when running in a burst mode is provided. The average current in burst mode is determined by the current laser duty cycle. When a laser is transmitting a lot of data bursts upstream in a PON, the duty cycle (e.g. the % of total time the laser is on) may near 100%. The variation in wavelength from drive current is either well-known or may be determined by a simple test, such as shown in FIG. 2 for example, where the drive current is changed and the wavelength shifts as the current related temperature change reaches steady state. Given this characteristic, an equal and opposite reduction in temperature may be effected by reducing the current to the tunable heater element or increasing the current to a ThermoElectric Cooler (TEC). A tunable laser often already has a heater or TEC. Hence, in such embodiments, new components do not need to be added to the laser assembly to implement the techniques described herein.

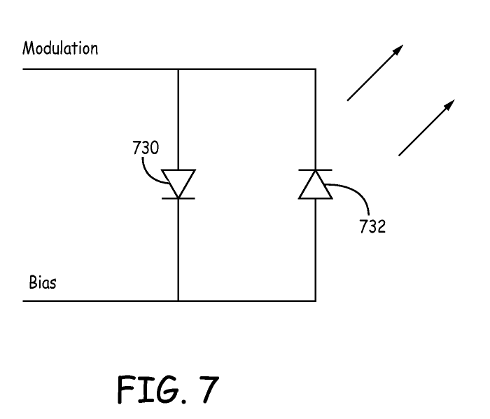

In some embodiments, the thermally tuned laser is based only on a heater. In other embodiments, the thermally tuned laser is based only on a TEC. In another alternative embodiment, a third option exists of having a hybrid Heater/TEC. In some implementations using a hybrid Heater/TEC, the heater can have a much smaller thermal mass than a TEC and can be located near where the laser junction is and allow faster response time than a TEC. In particular, the ‘heater’ can be implemented as a dual diode mechanism, as shown in the exemplary FIG. 7, with one diode being the laser junction diode 732 and another being the heater diode 730 such that it would sink equivalent power whether or not the laser is emitting. The heater diode 730 can be constructed in a nearly identical structure as the Laser emitting diode 732 (burst transmission diode) without coupling the photonic emissions to the fiber. In the embodiment of FIG. 7, the heater diode 730 is controlled at an opposite polarity to the burst transmission diode 732. The resulting thermal profile effectively mimics that of a continuous transmission diode. An added benefit of implementing the “heater” function as a silicon diode or gate is that it allows co-fabrication upon a common process and hence reduces fabrication costs. In some hybrid Heater/TEC implementations, the TEC compensates for long term wavelength drift and the heater/diode for short term.

In implementations using a continuous dual diode/heater approach, excessive power consumption can result because essentially the laser is “ON” all of the time even if light isn't being emitted. To address the excessive power consumption, in some embodiments, the laser in transceiver 401 is ‘pre-heated’ only just before the laser is about to transmit an optical burst. This preheating is made possible because the ONU 412 knows in advance when it is about to transmit a burst since bursts are scheduled by the OLT and this schedule is transmitted in the downstream to the ONU 412. In other words, the PON scheduling mechanism is used to ‘warm up’ the laser in advance of a burst with the heater/diode. Since the short term effects are on the order of microseconds, the additional power consumption by the pre-heating stage should be small, especially for ONUs that are essentially idle (the low duty cycle ONUs which have the potential for power savings). In the limit of 90% or above duty cycle, this pre-heating approach would have power consumption results similar to the continuous dual diode/heater implementation.

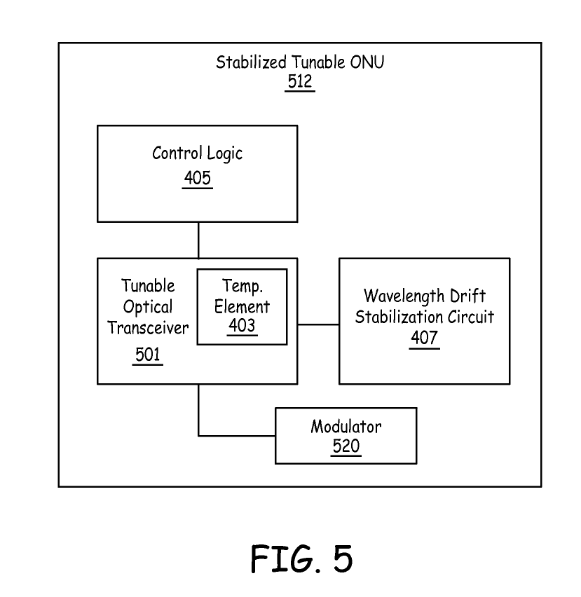

In another embodiment, an externally modulated laser (EML) is used, as shown in FIG. 5. That is, the light from the laser transceiver 501 in the ONU 512 is modulated by an external modulator 520. In some such embodiments, the EML 501 is powered on in advance of the burst. That is, the EML 501 is powered on prior to the schedule time for a burst transmission. The external modulator 520 receives the light form the EML 501 and allows the light to enter the fiber at the beginning of the optical burst. In other words, the external modulator 520 allows the burst to be transmitted on the fiber at the scheduled time even though the laser in the transceiver 501 is turned on prior to the scheduled time. In this way, the EML 501 is able to stabilize and the external modulator 520 determines when the light is permitted to be transmitted on the optical fiber. For power saving reasons, the EML 501 can be shut down for extended idle periods.

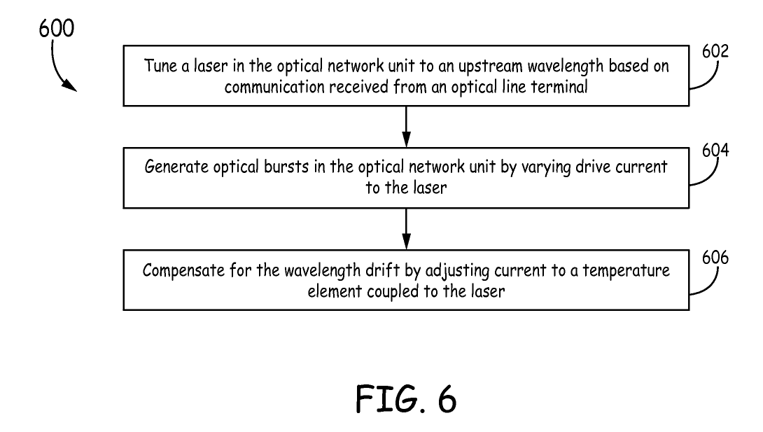

FIG. 6 is a flow chart depicting one embodiment of an exemplary method 600 of a method of stabilizing the variation in laser wavelength of an optical network unit in an optical network due to temperature induced wavelength shift. Method 600 can be implemented in an optical network unit, such as the optical network units described in FIGS. 1, 4 and 5. At block 602, a laser in the optical network unit is tuned to an upstream wavelength based on communication received from an optical line terminal communicatively coupled to the optical network unit, as described above. At block 604, optical bursts are generated by the optical network unit by varying drive current to the laser, as discussed above. The varying drive current changes a laser die temperature of the laser. The changing laser die temperature causes wavelength drift in the output of the optical network unit.

At block 606, the wavelength drift is compensate for by adjusting current to a temperature element coupled to the laser. In some embodiments, the temperature element is a heater, as described above. In other embodiments, the temperature element is a thermoelectric cooler. In yet other embodiments, the temperature element includes both a heater and a thermoelectric cooler. In some such embodiments, current to the thermoelectric cooler is adjusted to compensate for long term wavelength drift and current to the heater is adjusted to compensate for short term wavelength drift. In some embodiments, compensating for wavelength drift also comprises pre-heating the laser just before the laser is to transmit an optical burst based on a schedule distributed to the optical network unit. In addition, in some embodiments, compensating for wavelength drift comprises powering on the laser prior to a scheduled time for a burst transmission. The optical signal from the laser is received at an external modulator coupled to an output of the laser. The modulator permits the optical signal to be transmitted on an optical fiber at the scheduled time for the burst transmission, as described above.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. An optical node comprising:
a tunable optical transceiver having a laser and a temperature element; and
a wavelength shift stabilization circuit configured to adjust current provided to the temperature element such that wavelength shifts, due to changes in a drive current applied to the tunable optical transceiver, are reduced.

2. The optical node of claim 1, wherein the temperature element is a heater.

3. The optical node of claim 2, wherein the heater is implemented as a dual diode mechanism with one diode being a laser junction diode and another being the heater such that dual diode mechanism sinks equivalent power whether or not the laser is emitting.

4. The optical node of claim 3, wherein the dual diode mechanism is configured to pre-heat the laser just before the laser is to transmit an optical burst based on a schedule distributed to the optical node.

5. The optical node of claim 1, wherein the temperature element is a thermoelectric cooler.

6. The optical node of claim 1, further comprising a modulator coupled to an output of the tunable optical transceiver;
wherein the tunable optical transceiver is configured to power on the laser prior to a scheduled time to transmit an optical burst;
wherein the modulator is configured to permit an optical signal output from the tunable optical transceiver to be transmitted on an optical fiber coupled to the optical node based on the scheduled time to transmit.

7. The optical node of claim 1, wherein the temperature element includes a thermoelectric cooler and a heater;
wherein the thermoelectric cooler compensates for long term wavelength drift and the heater compensates for short term wavelength drift.

8. An optical network comprising:
an optical line terminal having one or more transmitters configured to transmit optical signals and one or more receivers configured to receive optical signals, wherein each of the one or more transmitters and each of the one or more receivers is configured to operate over a respective frequency within a frequency band;
a plurality of optical network units coupled to the optical line terminal, wherein each of the plurality of optical network units comprises:
an optical laser configured to transmit optical bursts to the optical line terminal;
a temperature element coupled to the optical laser; and
a wavelength shift stabilization circuit configured to adjust current provided to the temperature element to compensate for wavelength shifts due to changes in a drive current applied to the optical laser.

9. The optical network of claim 8, wherein the temperature element in one or more of the respective optical network units is a heater.

10. The optical network of claim 9, wherein the heater is implemented as a dual diode mechanism with one diode being a laser junction diode and another being the heater such that dual diode mechanism sinks equivalent power whether or not the laser is emitting.

11. The optical network of claim 10, wherein the dual diode mechanism is configured to pre-heat the laser just before the laser is to transmit an optical burst based on a schedule distributed to the optical network unit from the optical line terminal.

12. The optical network of claim 8, wherein the temperature element in one or more of the respective optical network units is a thermoelectric cooler.

13. The optical network of claim 8, wherein one or more of the optical network units further comprises a modulator coupled to an output of the laser;
wherein the laser is configured to power on prior to a scheduled time to transmit an optical burst;
wherein the modulator is configured to permit an optical signal output from the laser to be transmitted on an optical fiber coupled to the optical network unit based on the scheduled time to transmit.

14. The optical network of claim 8, wherein the temperature element in one or more of the respective optical network units includes a thermoelectric cooler and a heater;
wherein the thermoelectric cooler compensates for long term wavelength drift and the heater compensates for short term wavelength drift.

15. A method of stabilizing variation in laser wavelength of an optical network unit in an optical network, the method comprising:
tuning a laser in the optical network unit to an upstream wavelength based on communication received from an optical line terminal communicatively coupled to the optical network unit;
generating, with the optical network unit, optical bursts at the upstream wavelength by varying drive current to the laser, wherein varying the drive current changes a laser die temperature of the laser; and
compensating for wavelength drift caused by the varying laser die temperature by adjusting current to a temperature element coupled to the laser.

16. The method of claim 15, wherein compensating for wavelength drift further comprises pre-heating the laser just before the laser is to transmit an optical burst based on a schedule distributed to the optical network unit.

17. The method of claim 15, wherein adjusting current to a temperature element comprises adjusting current to a heater.

18. The method of claim 15, wherein adjusting current to a temperature element comprises adjusting current to a thermoelectric cooler.

19. The method of claim 15, wherein adjusting current to a temperature element comprises adjusting current to both a thermoelectric cooler and a heater;
wherein the thermoelectric cooler compensates for long term wavelength drift and the heater compensates for short term wavelength drift.

20. The method of claim 15, wherein compensating for wavelength drift further comprises:
powering on the laser prior to a scheduled time for a burst transmission;
receiving an optical signal from the laser at a modulator coupled to an output of the laser; and
permitting the optical signal to be transmitted on an optical fiber by the modulator at the scheduled time for the burst transmission.
